(19) United States
(12) Patent Application Publication
(10) Pub. No.: US 2026/0266632 A1
(43) Pub. Date: Sep. 10, 2026

(54) MICROFLUIDIC COMPUTATIONAL SEALS AND METHODS FOR RECORDING DAMAGE AND TAMPER EVENT MODALITIES

(71) Applicant: National Technology & Engineering Solutions of Sandia, LLC, Albuquerque, NM (US)

(72) Inventors: Jason E. Heath, Edgewood, NM (US); Thomas A. Dewers, Albuquerque, NM (US); Jacob A. Harvey, Rio Rancho, NM (US); Steven N. Giles, Albuquerque, NM (US); Angela C. Montoya, Albuquerque, NM (US); Agus R. Poerwoprajitno, Albuquerque, NM (US); Samuel D. Parker, Denver, CO (US); Dale L. Huber, Albuquerque, NM (US); Kristopher L. Kuhlman, Albuquerque, NM (US); Robert Finch, Penasco, NM (US); Joshua C. Shank, Albuquerque, NM (US)

(21) Appl. No.: 19/558,100

(22) Filed: Mar. 5, 2026

Related U.S. Application Data
(60) Provisional application No. 63/767,952, filed on Mar. 6, 2025.

(51) Int. Cl. G01D 9/00; G01H 3/00

(52) U.S. Cl. CPC G01D 9/005; G01H 3/00

(57) ABSTRACT

Knowledge of tamper modality diagnostics underlies creation of cost-effective, fit-for-purpose, next-generation seals that discriminate unauthorized tamper/breach/repair from noisy facility operations. Computational Seals are non-electronic, zero power, field-verifiable microfluidic-based seals that sense and analyze container intrusion attempts with memory of tamper modalities. Computational Seals involve hydraulic and chemical microfluidic components for sensing, discriminating, recording, and in-field read-out of vibration and other modality histories for tamper and damage identification, as filtered from facility operations. Computational Seals also sense and discriminate bulk movement of the container or containment to which they are attached.

### RELATED APPLICATIONS

This application claims priority to U.S. Patent Provisional Application 63/767,952, filed Mar. 6, 2025, entitled “MICROFLUIDIC COMPUTATIONAL SEALS AND METHODS FOR RECORDING DAMAGE AND TAMPER EVENT MODALITIES,” the entirety of which is incorporated herein by reference.

### STATEMENT OF GOVERNMENT INTEREST

The United States Government has rights in this invention pursuant to Contract No. DE-NA0003525 between the United State Department of Energy and National Technology & Engineering Solutions of Sandia, LLC, both for the operation of the Sandia National Laboratories.

### FIELD

The present disclosure is generally directed to containment systems and tamper-and/or damage-indicating devices used to maintain continuity knowledge on health and integrity of facilities, containers, packages, and/or equipment.

### BACKGROUND

Industry state-of-the-art uses visual indicators for the integrity of or environmental conditions experienced by a container or package when shipped or handled. Sensing modalities for readily-available “damage” indicators include the following: shock at or above a single given acceleration or g-force level; tilt beyond a certain angle; temperature indicating freezing or heat exposure; humidity experienced over specified ranges; and oxygen absence or presence in a given range. These devices typically include an adhesive and are applied on the outside of a container or can be placed inside. Some of these devices may undergo an irreversible change and are not re-used, but some may be reset. These devices are zero-electrical-power, typically low-cost, easy-to-apply, and easy-to-read, but they are limited in the history and number events they record. Industry also applies a variety of tamper-proofing devices to resist, deter, or detect unauthorized access to contents of a container, but these are typically limited to indicating opening through a certain region (e.g., lid) as opposed to whole-container integrity monitoring or for monitoring the health and state of the internal contents.

Safeguards of critical assets includes containment and surveillance measures and monitoring. It is generally considered that containment can be structural features of a facility, containers, and/or equipment that surround the safeguarded assets and prevent undetected access to or movement of the assets. Containment and surveillance devices often include seals, which are tamper-indicating devices to prevent undetected access without opening or breaking the seal and/or the containment. It is generally understood that containments are to prevent undetected access or movement of safeguarded material, which can include structural features of a facility, containers, and equipment. Components of sealing systems are the containment, procedures for applying the seal, and the seal itself.

Safeguards sealing systems are typically designed to detect tampering to a containment during which the seal body or cabling connected to the seal are disturbed. It is important that improvements for sealing systems include in-field detection and identification of modalities of tampering or physical attack by drilling, prying, cutting, or other such physical entry approaches that do not require subsequent verification at a remote location from the site in question. Furthermore, improvements could include monitoring of unauthorized movement of safeguarded containers.

What is needed are sealing systems and damage-indicating devices that require zero electrical power and which perform sensing, discriminating, and recording functions, with field verifiable read-outs, all incorporated within the seal itself. Discrimination of tamper modality—including unauthorized breaching and repair—by seals with sensors may be obscured by a variety of normal routine activities at facilities such as opening/closing (e.g., according to allowed procedures) or accidental-but-non-nefarious breakage of seals. Thus, safeguards and sealing systems need to be “hardened” to operational noise or be able to discriminate unauthorized tamper, breach, and repair of sealing systems and associated signals, including normal versus unauthorized movement of containers. Seals that monitor whole container health/integrity are needed.

### SUMMARY OF THE DISCLOSURE

Computational seals are zero-power components and devices incorporated into the body of containment seals that monitor health and integrity of safeguarded containers and/or record information on tampering types and events. The components and devices sense tamper, breach, and repair events to containers by sensing, responding to, and discerning or discriminating tamper modalities as based on mechanical event vibration or shock frequency, magnitude, and other attributes. Computational Seals record timing and duration via chemical precipitate timers that record duration of discrete events and the time since the events occurred. Read-out for in-field verification or identification of tamper events includes the following options: direct visual displays; and hand-held field-deployable readers that interface with the Computational Seals to read their state via passive radio frequency methods and/or time-domain reflectometry via embedded waveguides in the seals. Computational Seals involve microfluidics inside the seals to perform the sensing, discriminating, recording, and read-out functionality that manifests in channel geometry, combinations of immiscible fluids, controlled surface wettability, coupled passive electrical and microfluidic circuits, and embedded electromagnetic wave guidelines.

Computational Seals can improve inspection efficiency and protect against environmental damage by being zero power (e.g., no battery replacement; continuous monitoring) and facilitating in-field identification of unauthorized tamper, breach, or repair of sealing systems and the modalities thereof. Computational seals, when attached to the container body, sense tamper, breach, and repair events to the container or containment body and not just the seal itself. Computational Seals furthermore act as damage history indicators for multiple events, type of events, and their history as opposed to registering a single event like currently available zero-power technology.

According to an embodiment, a system is disclosed that includes a microfluidic circuit comprising capillary tubing, reservoirs, a first fluid and a second fluid; and a measurement device that measures pressure applied by displacement or movement of the first fluid. Pressure indicates a shock or vibration sensed by the microfluidic circuit that further indicates a tamper, damage or motion event.

According to another embodiment, a method is disclosed that includes energizing a fluid within a microfluidic circuit by shock or vibration; measuring displacement of the fluid within the microfluidic circuit; and interrogating the microfluidic circuit to determine if the microfluidic circuit was subject to a shock or vibration that indicates a tamper or motion event.

According to another embodiment, a method is disclosed that includes sensing, discriminating and recording a tamper, motion or damage modalities by a zero electrical power microfluidic circuit that are triggered by any one of vibration, shock, motion, temperature change, humidity change and electrical/magnetic change; recording a fluid response to tamper and damage modalities involving vibration-shock, rotation, temperature change, humidity change, and electrical/magnetic responses; and discriminating the recorded fluid response to correspond to an event. g-force-sensitive microfluidic capillary triggers and microfluidic logic gates, hydraulic logic circuits, and traveling chemical precipitates for sensing, discriminating, and recording tamper or damage modalities that generate shock and vibration. Networks of microfluidic capillary triggers, logic gates, and/or analog microfluidic sensing to discriminating tamper or damage event characteristics such as vibration-shock generating event waveform. Discriminating capability to separate tamper and damage events into classes for separating from facility or other sources of non-tamper events from facility noise. Traveling chemical precipitates in calibrated channels to record duration of events and time-since events, with tuning of kinetics for tuning periods of recording. Read-out functionality by visual displays and/or passive battery-free radio frequency methods and time-domain reflectometry that involves conductive fluids and/or waveguides to confirm the state of the microfluidic components and component networks.

### BRIEF DESCRIPTION OF THE DRAWINGS

The detailed description will refer to the following drawings, wherein like elements are referred to by like numbers.

FIG. 1 illustrates a container with a tamper detection device according to an embodiment of the invention.

FIG. 2A is an illustration of an inertial capillary switch valve initially (at rest) according to an embodiment of the disclosure (hatched areas depict water, stippled areas depict air).

FIG. 2B is a schematic illustration of an inertial capillary switch valve when triggered (1 ms) according to an embodiment of the disclosure.

FIG. 2C is a schematic illustration of an inertial capillary switch valve showing initial flow through the valve (at 1.2 ms) blocking the air (stippled) flow between the inlet and outlet according to an embodiment of the disclosure.

FIG. 2D is a schematic illustration of an inertial capillary switch valve showing flow through the valve (at 1.6 ms) blocking air (stippled) flow between the inlet and outlet according to an embodiment of the disclosure.

FIG. 2E is a schematic illustration of an inertial capillary switch valve showing valve flow at rest (2.0 ms) according to an embodiment of the disclosure.

FIG. 2F shows a triangular wave of magnitude of 100 g used in driving the inertial capillary switch valve from FIG. 2A to FIG. 2E (x-axis is in ms, y-axis is in fraction of total applied force).

FIG. 3A is a schematic illustration of an inertial capillary switch valve showing valve flow at rest according to an embodiment of the disclosure.

FIG. 3B is a schematic illustration of an inertial capillary switch valve showing valve flow being motion activated according to an embodiment of the disclosure.

FIG. 3C is a schematic illustration of an inertial capillary switch valve showing valve flow with side valve activation according to an embodiment of the disclosure.

FIG. 3D is a schematic illustration of an inertial capillary switch valve showing valve flow at balanced mixing according to an embodiment of the disclosure.

FIG. 3E is a schematic illustration of an inertial capillary switch valve showing valve flow at rest after balanced mixing according to an embodiment of the disclosure.

FIG. 3F is a schematic illustration of a square wave with peak 15 g magnitude used as the driving function for the inertial capillary switch valves of FIGS. 3A-3E according to an embodiment of the disclosure (x-axis is in ms, y-axis is in fraction of total applied force).

FIG. 4 illustrates an exemplary model of a traveling precipitate wave (hatched area) in a serpentine microfluidic channel (stippled area).

FIG. 5 shows an exemplary timeline of simulated tampering and breaching as recorded by an enDAQ accelerometer on a 55-gallon drum.

### DETAILED DESCRIPTION OF THE DISCLOSURE

The present disclosure is directed to sensors that measure and record applied forces that can be related to intrusion and motion events. When the sensors are incorporated into a seal, the seal may be referred to as a computational seal (CS).

The sensor uses capillary microfluidics that are designed to sense and record physical and surface forces using hydraulic and chemical network attributes or processes related to immiscible liquids and the solid substates. The sensor uses geometries of reservoirs, inertial masses, localized constrictions, and microchannels and their arrangements and connectivity to sense and record applied forces. The sensor also uses the contact angles and wettability of the fluids on the solid surfaces, including regions of the devices that may be wetting or non-wetting to the fluids. The sensor uses non-linear far-from-equilibrium chemical reactions as Liesegang bands for traveling precipitates in channels to record magnitude and elapsed time since detection.

The presently disclosed sensors are designed to sense both impulse and periodic events that generate vibration or shock, discriminate attributes of the events, and record the duration and the time interval since the event occurred. The vibration and/or shock are sensed by the sensor as an externally applied force through relative motion of inertial solid and liquid components. In various embodiments, the sensor may be constructed as hydraulic or microfluidic logic gates that operate via digital logic on volumes of liquid as inputs and outputs due to energy (force) imparted from tampering or other events that generate vibration or shock, and/or they may manifest in analog functionalities that respond with diagnostic outputs for the event. The event may be, but is not limited to tampering, motion or momentum change, dropping, or rotation that produce a vibration or shock. For example, the event may be, but is not limited to, cutting by such tools as a sawzall, drill, sheet-metal cutter, grinder, nibbler, cutting wheel, or similar tools. The term tamper extends to movement and reconfiguration of the container to affect breach of containment for removal of material and containment repair of unauthorized breaching.

A sensor may be embedded in various components and materials, such as but not limited to seals, housings, junction boxes, or connectors. In some embodiments, one or more sensors may be embedded in seals that are used to seal a container. In these embodiments and as discussed above, the seal may be referred to as a computational seal (CS).

The microfluidic design principles of the sensor are configured to sense, discriminate, record, and read-out tamper events. Furthermore, various embodiments herein disclose the class of materials, including fluids and solids, fabrication techniques, and data collection for supporting seal component/device designs and validation to enable production of the seals.

The sensors are designed to operate without electrical power, utilizing hydraulic-mechanical-chemical components to monitor container integrity and detect tampering events. Microfluidic logic gates, inertial pumps, and capillary switches are employed to sense and record tamper events, leveraging changes in fluid dynamics to detect vibration-shock, rotation, temperature, and humidity changes. The system can discriminate between different tamper modalities by analyzing and reading out the fluid flow patterns and precipitate formation within the microfluidic channels. The zero-power nature of the components ensures continuous monitoring without the need for external power sources, making them ideal for long-term deployment in safeguarded containers. The components can also be resistant to high-radiation environments or electromagnetic interference. Inertial capillary triggers are designed to respond to shock or periodic g-forces, initiating fluid flow when a threshold acceleration of a predetermined nature is exceeded, thus detecting shock and vibration events. Furthermore, microfluidic components may be arranged as networks of logic gates and/or analog devices for discriminating features of events such as the vibration/shock signal intensity, the varying energy of the signal, signal periodicity, or frequency spread, which may be diagnostic of the potential tamper events or facility noise.

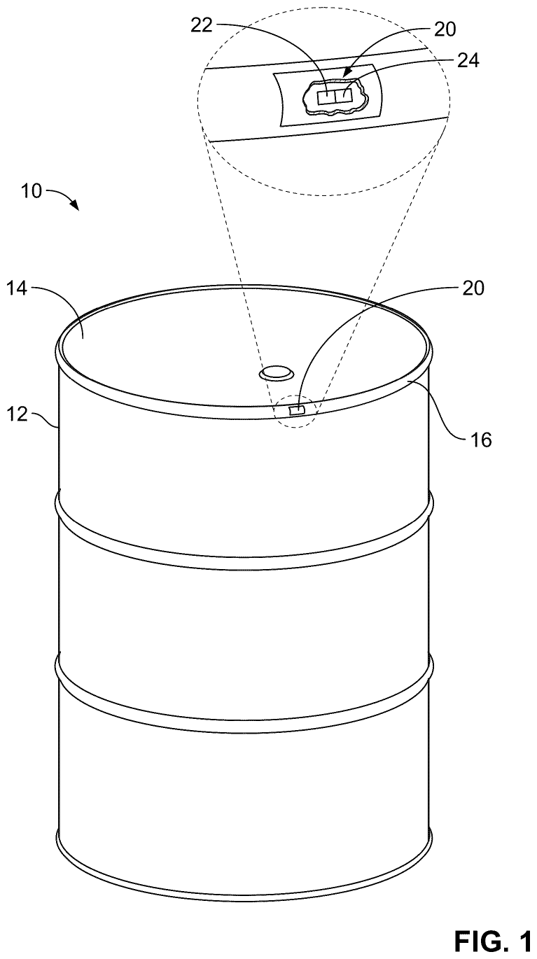

FIG. 1 illustrates a sensor 20 embedded in a seal 16 that is used to seal a drum 10. The drum 10 includes a body 12 and a lid 14. The seal 16 seals the lid 14 to the body 12. The seal 16 may be referred to as a computational seal (CS). The sensor 20 includes a microfluidic switch 22 and a sensor and recoding package 24. The microfluidic switch 22 will be discussed in further detail below but is generally described as a microfluidic chamber that reacts to vibration and/or shock to displace a fluid that can be measured by the sensor and recording package 24.

The sensor and recording package 24 is also disclosed in further detail below but is generally described as including a sensor that responds to change in fluid pressure imparted by movement of an inertial body or fluid and an event recording device for recording the sensed state. In various embodiments, the device may be a microfluidic circuit or combination of microfluidic and electrical circuits described in further detail below.

In the exemplary embodiment shown in FIG. 1, the sensor 20 is disposed in a seal 16 used to join two container components. The seal 16 may be formed of conventional seal materials such as, but not limited to, hard plastics and metals. In other embodiments, the sensor 20 may be embedded in paints, adhesives, panels and structural components.

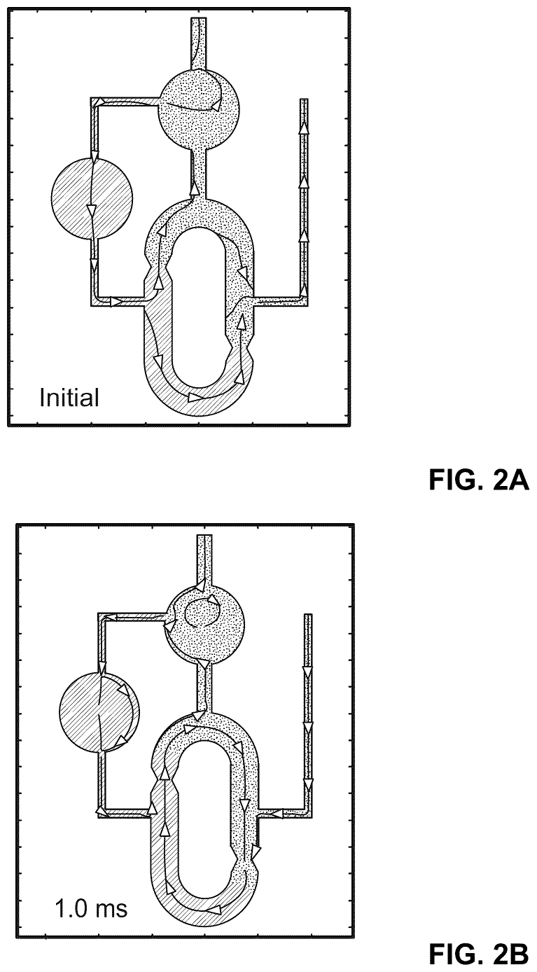

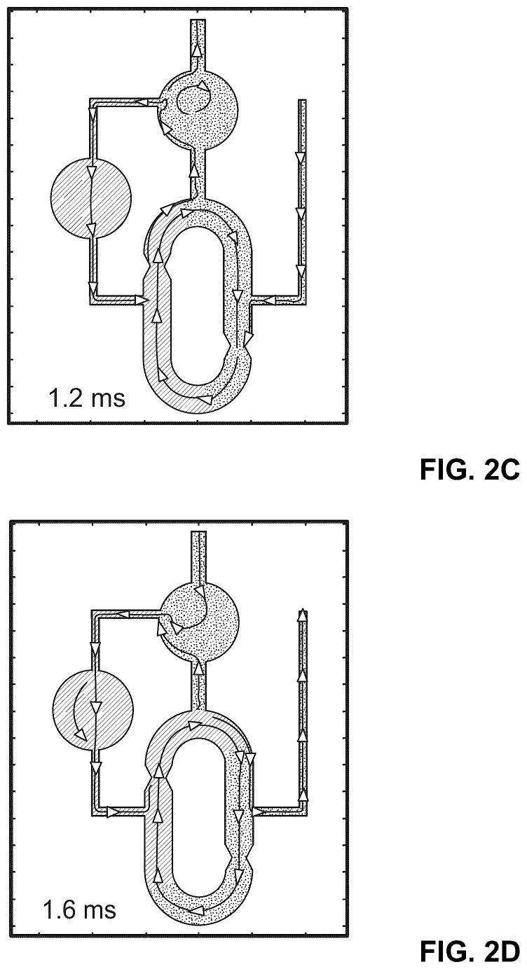

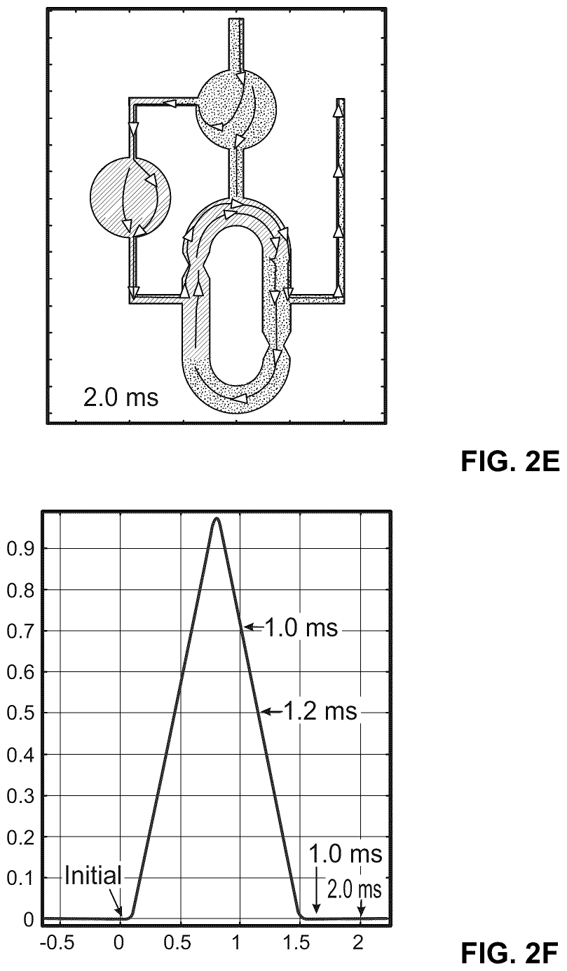

FIGS. 2A-2E illustrate an inertial fluid capillary switch valve numerical simulation that functions as a NOT logic gate and is sensitive to accelerations in the vertical direction. Hatched depicts liquid water and stippled depicts air. In other embodiments, the liquid may be other than water, for example oil, alcohol or other liquid selected on the sensitivity and/or design of the circuit. Also, in other embodiments, air may be replaced by other gases such as but not limited to an inert gas. FIG. 2A illustrates the valve in at initial state, at rest. FIG. 2B illustrates when the valve is triggered by a saw wave as depicted in FIG. 2F of magnitude of 100 g. FIGS. 2C through 2D illustrate flow through the valve blocks as the air flows between the inlet and outlet and produces an air pressure in excess of atmospheric. FIG. 2E shows the valve flow at rest. In such a manner, the valve as a microfluidic logic gates, such as NOT, AND, and NOR gates, constructed from capillary switches to process the fluid signals and perform Boolean functions.

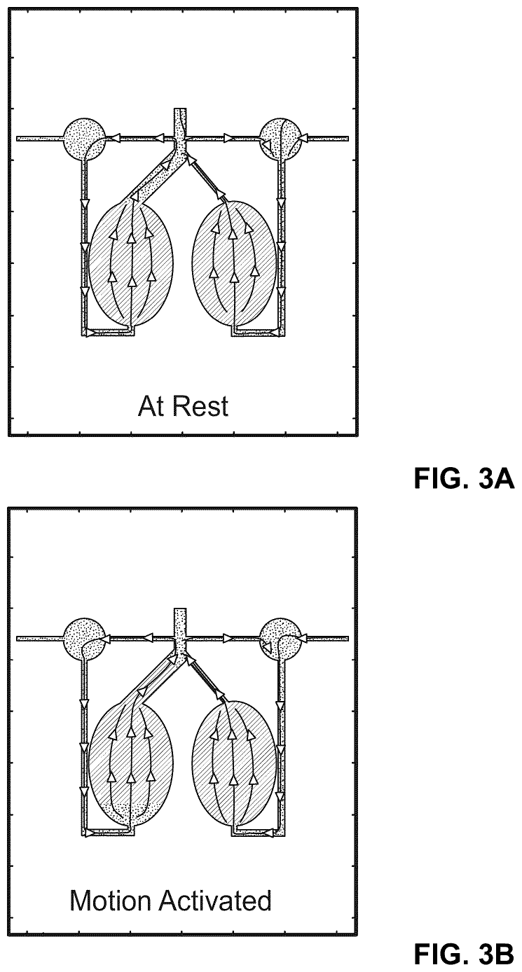

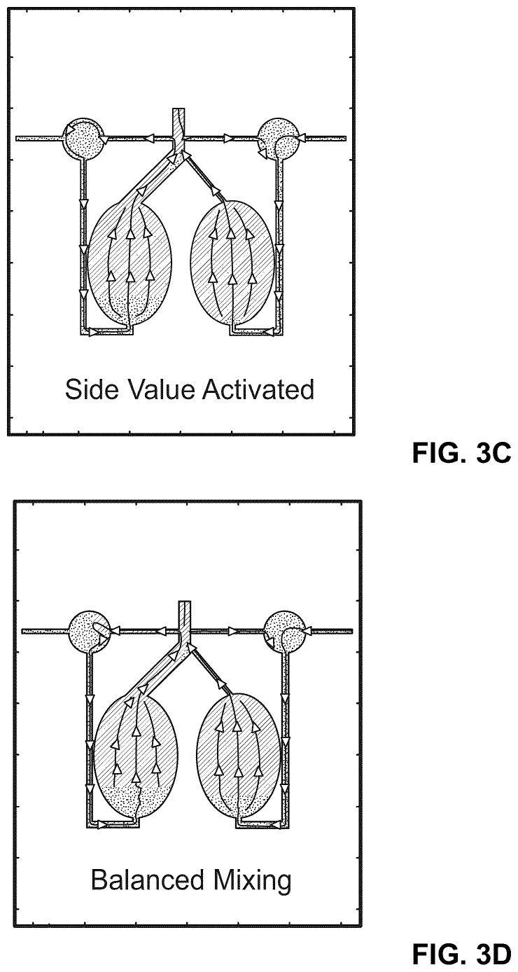

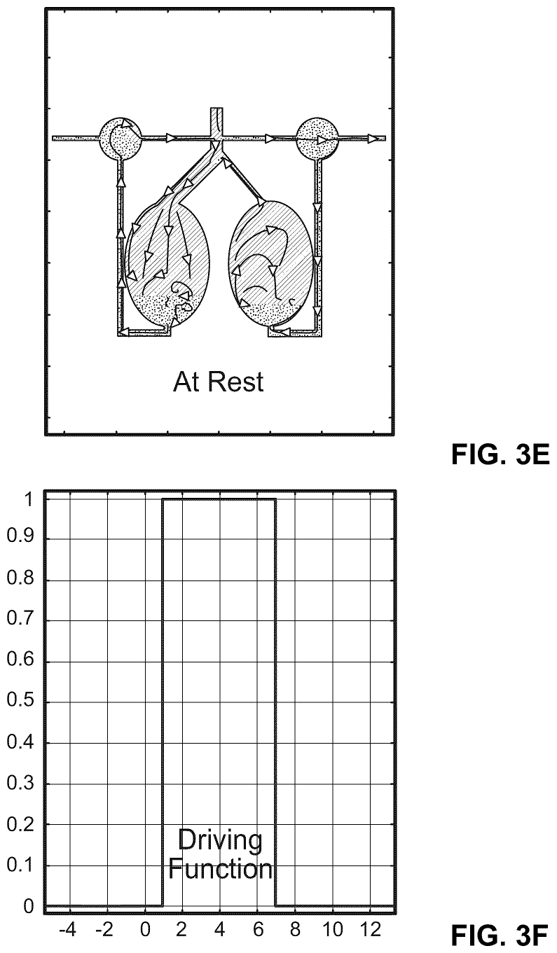

FIGS. 3A-3E illustrate an embodiment of a valve with an AND microfluidic logic gate as the valve is triggered, reacts and ends at a rest state. As above, hatched represents liquid water, stippled represents air. FIG. 3A illustrates when the fluid/geometry is initialized. The driving function here is a square wave shown in FIG. 3F and which has a peak magnitude of 15 g. This produces a flow from reservoir as shown in FIG. 3B and activates flow from reservoir as shown in FIGS. 3C through 3D. FIG. 3E shows the system at rest, with fluid in the reservoirs sufficient to record another subsequent event.

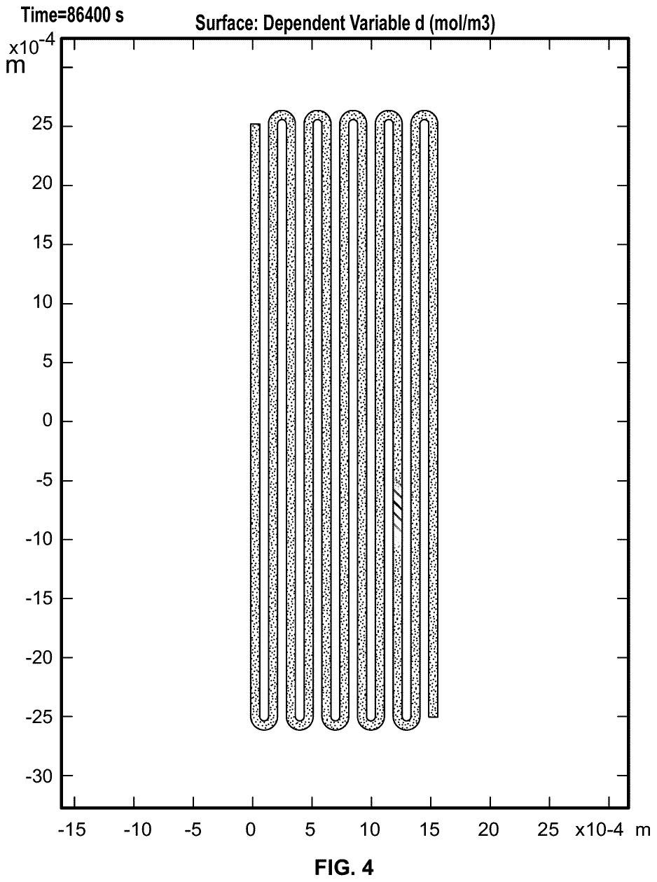

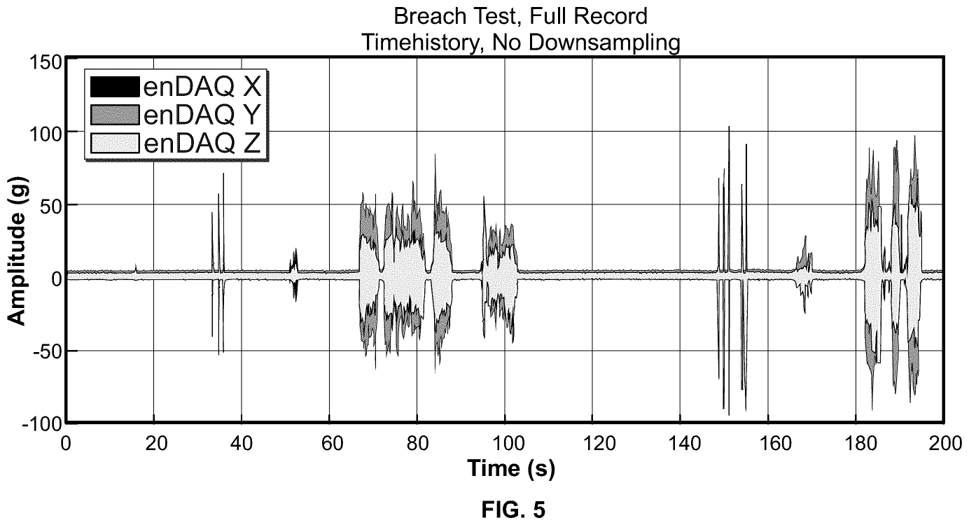

As described in the embodiments shown in FIGS. 2A-2E and FIGS. 3A-3E, hydraulic logic circuits are used to route the fluid through the microfluidic network, enabling complex signal processing and event discrimination. In various embodiments, traveling chemical precipitates within the channels provide a means to record the occurrence, duration, and elapsed time since tamper events, with the precipitate formation being triggered by the fluid flow induced by shock or vibration (see FIG. 4 and the discussion below). In other embodiments, the displaced fluid may be used to complete an intentionally incomplete electrical circuit (e.g., an antenna in place, but missing a final electrical connection), by either the presence of electrically conducting fluid across the gap in the circuit or due to expansion of fluid-sensitive components (e.g., paper) with metal foils to complete electrical circuits. The electrical circuit that is completed by the fluid can complete a radio-frequency identification (RFID) circuit that could be sensed by a recording device.

A database can be created that includes signals of demonstrated shock and vibration events. The events recorded by the CS can be compared to the database to determine the type of events. In such a manner, the computational seals utilize networks of microfluidic components to analyze and discriminate tamper events based on their unique vibration-shock waveforms and other characteristics that may include, but are not limited to, signal intensity, periodicity, and/or frequency spread that may be diagnostic of the potential tamper events, facility noise, or vibration from movement of a container or containment. Capillary triggers and logic gates are interconnected to form a network that processes the fluid signals generated by tamper events, allowing for detailed characterization of the event waveform. Analog microfluidic sensing can also provide continuous monitoring and real-time analysis of the fluid dynamics, enabling the system to distinguish between different types of tamper events based on their vibrational signatures.

The microfluidic network is designed to discriminate between tamper events and non-tamper events through readout by RFID and time since the event occurred can be estimated from the progress in a precipitate formation reaction. Time-domain reflectometry via embedded waveguides in the seals is also an option to read the state of fluids in the devices that maps to discrimination of vibration/shock events. The system can classify events based on their unique characteristics, such as amplitude, waveform shape, and duration, allowing it to separate tamper events from facility noise and other non-tamper sources. This discrimination capability is essential for ensuring that only genuine tamper events are recorded and reported, reducing false positives and improving the reliability of the monitoring system.

Microfluidic logic gates combine to form non-electronic microfluidic circuitry. Capillary switches are based on liquid-air or liquid-liquid (e.g. oil-water) interfaces and changes in channel geometry, such that overcoming the capillary pressure results in flow of a wetting liquid phase. Events such as discrete shock accelerations or vibrational events trigger capillary flow when exceeding a capillary threshold that is sensitive to fluid wetting properties and microfluidic geometries. Arrangements of microfluidic logic gates together with fluid resistors and capillary pumps known from capillary microfluidics yield unconventional computing circuits with mechanical-hydraulic-chemical components that analyze and record type, number and timing, and magnitude of discrete physical tampering events.

FIG. 4 illustrates an embodiment of a traveling precipitate wave in a serpentine microfluidic channel. The hatched area depicts an aluminum-hydroxide precipitate of approximately 0.1 mol/m³ that migrates from right to left at a rate proportional to the square root of time. Calibrated microfluidic channels are used to control the flow of fluids and the formation of far-from-equilibrium traveling chemical precipitates, which serve as a record of tamper events. Traveling or moving chemical precipitates offer a near irreversible means of recording timing since event and duration, as the solids do not re-dissolve quickly back into a saturated solution, and the solids are robust when held in a gel suspension, such as hydrogel. The kinetics of the precipitate formation can be tuned to adjust the recording period, allowing for precise measurement of the duration and time-since events.

The precipitation mechanism is limited by diffusive solute transport and is designed to extend via a reaction chamber connected to a mixing chamber connected to the outlets of the valving/logic gate configurations. Embodiments can be, but are not limited to, types of Liesegang-like precipitation patterns, both of which function under far-from-equilibrium conditions. Iron and aluminum hydroxide/oxy-hydroxide precipitates, with high nucleation thresholds, are used to avoid toxicity issues. These precipitates crystallize within hydrogel suspensions that are pre-loaded with anionic reactants. The iron hydroxide precipitates grow in banded patterns with the thickness and number of bands being proportional to the duration of the mixing event input into the reaction channels. The aluminum hydroxide precipitates form traveling waves with the traveled distance proportional to the square root of time-since event or another rate that can be predicted or calibrated. To enable long-time monitoring and also subsequent events, serpentine or spiral channel designs are utilized to fit a long channel into a small physical space. A numerical simulation of a traveling aluminum-hydroxide precipitate in a serpentine channel demonstrates this functionality (FIG. 3). This capability enables the system to provide detailed information on the timing and duration of tamper events, which is crucial for understanding the nature and impact of the tampering.

The state of the microfluidic components and networks can be confirmed through visual inspection of the fluid flow and precipitate formation within the channels. Passive battery-free radio frequency methods can be used to read out the status of the system without the need for external power sources. Time-domain reflectometry can also be used to monitor the movement of conductive fluids through and around waveguides, providing an additional method for confirming the state of the microfluidic components, ensuring accurate and reliable monitoring of tamper events.

Laboratory testing supports designs and tests the performance of both individual components and the integrated microfluidic system from vibration-shock and other modality standpoints. A use case can involve specific containers such as a 55-gallon drum with a secured lid, to obtain data to tailor and design computational seals for detecting seal tampering, bulk movement indicative of unauthorized activities, and breaching that bypasses seals (see FIG. 4).

FIG. 4 illustrates a timeline of simulated tampering and breaching as recorded by an enDAQ accelerometer on a 55-gallon drum. Two sets of activities were performed, each of which included the following: hammer and chisel; drill; and reciprocating saw. These data or similar data may be used to analyze vibrations that would be recorded by a CS to determine the type of event. By incorporating sensing and information processing functionalities, computational seals extend standard sealing technology to address container health and integrity. Fault tree analysis is used to define combination tampering activities and modalities, ensuring normal movements are not counted as tampering. Vibration and shock and other measurements are performed during bulk movements, such as transporting the drum on a flatbed truck and lifting it with a barrel lifter attached to a forklift. Simulated tampering activities can include, but are not limited to, striking the drum with a hammer and chisel, drilling through the side, and sawing with a reciprocating saw. These tests confirm the computational seals' sensitivity to continuous vibration sources and discrete impacts, as well as their ability to record sequences of events, and these activities generate data to design the computational seals.

Adding switches and resistors to microfluidic logic gate assemblies yields discriminating functions in the computational seals that sense mechanical perturbations including vibration, shock, jostling, and other movements. Algorithmic functionality allows to filter signals of standard operational perturbations (e.g. movement via fork-lift) from intrusion attempts such as drilling, sawing, chiseling etc. When included as part of sealing structures for in-use containers, computational seals compute and record discrete tampering events over extended time periods relevant for inspectorate, from months to a year.

Fabrication involves common techniques that can create channels and components below 100 microns in size, which may include 3D printing, lithographic, or other techniques. Surface treatment techniques modify wettability, and working fluids may include liquids that do not readily evaporate and that have appropriate surface tensions for the behavior of the capillary components and devices.

What is claimed is:

1. A system, comprising:
a microfluidic circuit comprising capillary tubing, reservoirs, a first fluid and a second fluid; and
a measurement device that measures pressure applied by displacement or movement of the first fluid;
wherein pressure indicates a shock or vibration sensed by the microfluidic circuit that further indicates a tamper, damage or motion event.

2. The system of claim 1, further comprising a seal, component or adhesive in which the microfluidic circuit is embedded.

3. The system of claim 1, wherein the measurement device comprises at least one device comprising discriminating circuity, recording circuity and read-out circuitry.

4. The system of claim 1, further comprising a seal into which the microfluidic circuit is embedded.

5. The system of claim 1, wherein the measurement device reacts to applied pressure by forming a precipitate that indicates time and an event.

6. The system of claim 1, wherein the first fluid is water and the second fluid is air.

7. A method, comprising:
energizing a fluid within a microfluidic circuit by shock or vibration;
measuring displacement of the fluid within the microfluidic circuit; and
interrogating the microfluidic circuit to determine if the microfluidic circuit was subject to a shock or vibration that indicates a tamper or motion event.

8. The method of claim 7, wherein the fluid moves within the microfluidic circuit by capillary action.

9. The method of claim 7, wherein the fluid is water.

10. The method of claim 9, wherein the water displaces air.

11. The method of claim 7, wherein measuring is performed by precipitation and precipitation travel.

12. A method, comprising:
sensing, discriminating and recording a tamper, motion or damage modalities by a zero electrical power microfluidic circuit that are triggered by any one of vibration, shock, motion, temperature change, humidity change and electrical/magnetic change;
recording a fluid response to tamper and damage modalities involving vibration-shock, rotation, temperature change, humidity change, and electrical/magnetic responses; and
discriminating the recorded fluid response to correspond to an event;
wherein g-force-sensitive microfluidic capillary triggers and microfluidic logic gates, hydraulic logic circuits, and traveling chemical precipitates for sensing, discriminating, and recording tamper or damage modalities that generate shock and vibration;
wherein networks of microfluidic capillary triggers, logic gates, and/or analog microfluidic sensing to discriminating tamper or damage event characteristics such as vibration-shock generating event waveform;
wherein discriminating capability to separate tamper and damage events into classes for separating from facility or other sources of non-tamper events from facility noise;
wherein traveling chemical precipitates in calibrated channels to record duration of events and time-since events, with tuning of kinetics for tuning periods of recording; and
wherein read-out functionality by visual displays and/or passive battery-free radio frequency methods and time-domain reflectometry that involves conductive fluids and/or waveguides to confirm the state of the microfluidic components and component networks.
